(19) United States
(12) Patent Application Publication
(10) Pub. No.: US 2013/0025908 A1
(43) Pub. Date: Jan. 31, 2013

(54) CONDUCTING WIRE STRUCTURE

(71) Applicants: Wen-Chi Liu, Taoyuan County (TW); Mao-Kuan Lin, Taoyuan County (TW)

(72) Inventors: Wen-Chi Liu, Taoyuan County (TW); Mao-Kuan Lin, Taoyuan County (TW)

(73) Assignee: FSP TECHNOLOGY INC., Taoyuan County (TW)

(21) Appl. No.: 13/555,205

(22) Filed: Jul. 23, 2012

(30) Foreign Application Priority Data
Jul. 26, 2011 (TW) 100126412

(51) Int. Cl. H01B 11/02

(52) U.S. Cl. 174/113 R

(57) ABSTRACT

A conducting wire structure for transmitting electric power is provided, which includes a plurality of first core wires and a plurality of second core wires twisted together with each other, in which each of the first core wires is composed of multiple metal materials, a first metal layer is located at the center of the first core wire and the first metal layer is clad in a second metal layer.

### CROSS-REFERENCE TO RELATED APPLICATION

This application claims the priority benefit of Taiwan application serial no. 100126412, filed on Jul. 26, 2011. The entirety of the above-mentioned patent application is hereby incorporated by reference herein and made a part of this specification.

### BACKGROUND OF THE INVENTION

1. Field of the Invention

The invention generally relates to a conducting wire structure, and more particularly, to a conducting wire structure used for transmitting electric power.

2. Description of Related Art

For a long time, a power supply has become an important part of an electronic equipment for electric power conversion. Along with the ceaseless development of electronic science and technology, Internet and multimedia technique have also gradually become mature so that the power supply for providing a stable electric power output must be grown accordingly.

A current conducting wire structure connecting the power supply for transmitting electric power is fabricated by twisting wires with a single metal (copper), which although has better current transmission efficiency, but the current merely flows along the surfaces of the copper wires due to the surface effect of current. With the situation, the copper wire at the central axis of a whole conducting wire is not the major portion for transmitting current. In addition, the copper wire self has a limited tensile strength and higher material cost. In this regard, how to appropriately improve the conventional conducting wire structure for transmitting electric power so as to advance the industrial utilization thereof becomes an important development issue.

### SUMMARY OF THE INVENTION

Accordingly, the invention is directed to a conducting wire structure with a better structure strength, a higher current transmission efficiency and a lower fabrication cost.

An embodiment of the invention provides a conducting wire structure for transmitting electric power, which includes a plurality of first core wires and a plurality of second core wires twisted together with each other, in which each of the first core wires is composed of multiple metal materials, a first metal layer is located at the center of the first core wire and the first metal layer is clad in a second metal layer.

In an embodiment of the present invention, the quantity of the above-mentioned first core wires occupies less than 50% of the sum of the quantities of the first core wires and the second core wires.

In an embodiment of the present invention, the above-mentioned conducting wire structure is used for transmitting electric power with voltage absolute values ranging from 3.3V to 60V, in which the voltage absolute value is 3.3V, 5V, 12V, 16V, 19V, 20V and 60V.

In an embodiment of the present invention, the above-mentioned first core wires are arranged at the center of the conducting wire structure and the second core wires are arranged roughly outside the first core wires.

In an embodiment of the present invention, the distances between those among the above-mentioned second core wires most close to the first core wires from the central axis of the conducting wire structure are substantially the same.

In an embodiment of the present invention, the proportion of the volume of the above-mentioned second metal layer over the volume sum of the first metal layer and the second metal layer is substantially less than 40%, between 32% and 38% or between 38% and 40%.

In an embodiment of the present invention, the material of the above-mentioned first metal layer is aluminium or aluminium-magnesium alloy and the material of the second metal layer is copper.

In an embodiment of the present invention, each of the above-mentioned first core wires further includes a protection layer cladding the second metal layer for preventing the conducting wire structure from oxidization and increasing the connection strength of the conducting wire structure electrically connected to other electronic components.

In an embodiment of the present invention, the material of the above-mentioned protection layer is tin.

In an embodiment of the present invention, each of the above-mentioned second core wires includes a copper wire and a tin protection layer outside the copper wire, in which the conducting wire structure is used for a switching power supply.

In an embodiment of the present invention, the diameter of the above-mentioned first core wire is between 0.17 mm and 0.19 mm.

In an embodiment of the present invention, the quantity sum of the above-mentioned first core wires and the second core wires is 21, 34 or between 7 and 34.

In an embodiment of the present invention, the heat-withstanding temperatures of the above-mentioned first core wires and the second core wires are greater than 90° C. and the temperature of the conducting wire structure during transmitting electric power is not over 90° C.

Based on the description, in the above-mentioned embodiment of the present invention, a conducting wire structure includes first core wires and second core wires twisted with each other, in which each of the first core wires is composed of multiple metal materials. In this way, under a better current transmission efficiency, the conducting wire structure has increased mechanical property and reduced fabrication cost by changing the metal materials and the proportions of the first core wires.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 schematic diagram of a conducting wire structure according to an embodiment of the invention.

FIG. 2 is a cross-sectional diagram of the conducting wire structure of FIG. 1.

FIGS. 3A and 3B are respectively cross-sectional diagrams of a first core wire and a second core wire in the conducting wire structure of FIG. 2.

### DESCRIPTION OF THE EMBODIMENTS

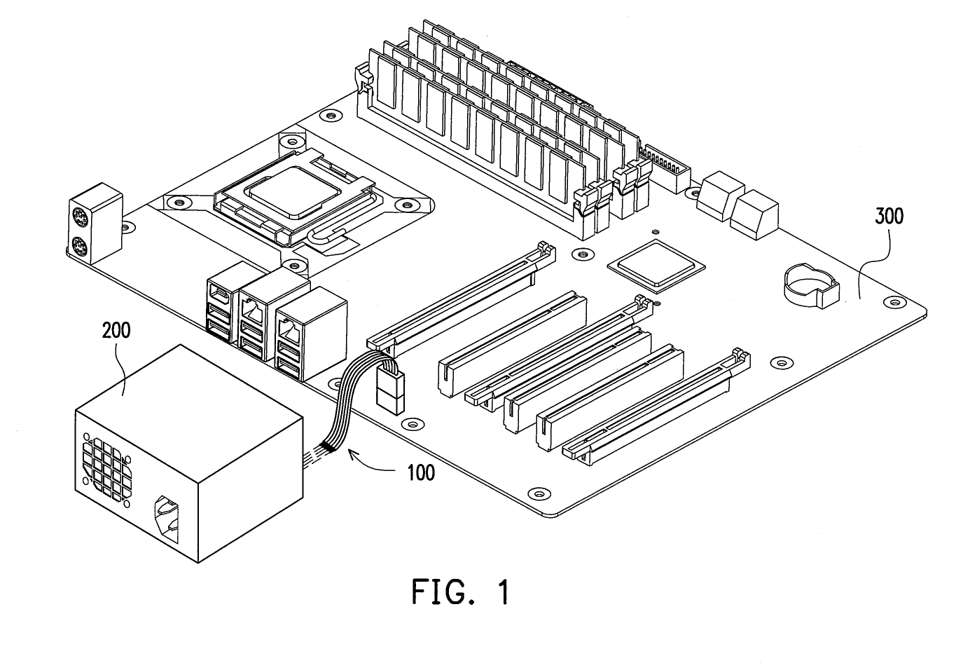

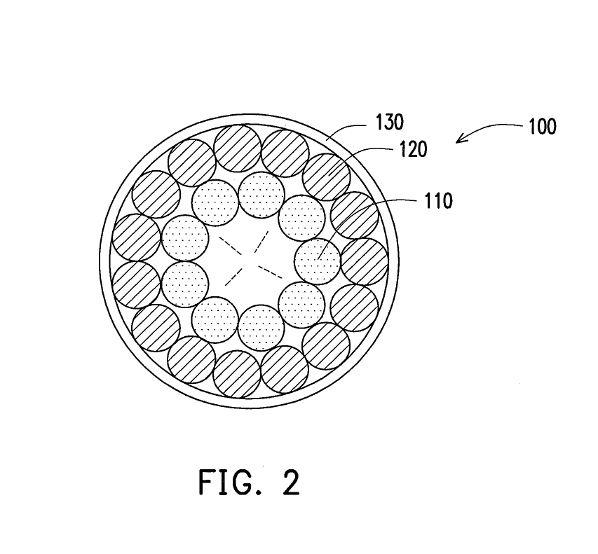

FIG. 1 schematic diagram of a conducting wire structure according to an embodiment of the invention and FIG. 2 is a cross-sectional diagram of the conducting wire structure of FIG. 1. Referring to FIGS. 1 and 2, in the embodiment, a conducting wire structure 100 is suitable to be connected between a switching power supply 200 and an electronic component 300 for transmitting electric power produced by the switching power supply 200 to the electronic component 300. The electronic component 300 herein is, for example, a motherboard, which the invention is not limited to. In FIG. 2, the conducting wire structure 100 means one of the conducting wires in FIG. 1.

In the embodiment, the conducting wire structure 100 includes a plurality of first core wires 110 and a plurality of second core wires 120 which are twisted together with each other, followed by cladding an insulation material 130 thereout. In the conducting wire structure 100, the quantity of the first core wires 110 occupies less than 50% of the sum of the quantities of the first core wires 110 and the second core wires 120, in which in order to keep a better current transmission efficiency with the conducting wire structure 100, the first core wires 110 and the second core wires 120 are mixed twisted with each other roughly in a quantity proportion of 1:1, so that the conducting wire structure 100 can conform to power 700 W application of the switching power supply 200. The quantity sum of the first core wires 110 and the second core wires 120 is 21, 34 or between 7 and 34, so that the conducting wire conducts electric power with better material strength and less energy consumption. The conducting wire structure 100 herein is able to transmit electric power with a voltage absolute range between 3.3V and 60V, in which the voltage absolute value preferably is 3.3V, 5V, 12V, 16V, 19V, 20V and 60V. In addition, for more clearly distinguishing the difference between the first core wires 110 and the second core wires 120, only the second core wires 120 and partial first core wires 110 adjacent to the second core wires 120 are shown in FIG. 2.

The first core wires 110 are arranged at the center of the conducting wire structure 100, while the second core wires 120 are arranged roughly outside the first core wires 110. In other words, the second core wires 120 are disposed surrounding the first core wires 110, i.e., the distances between those among the second core wires 120 most close to the first core wires 110 from the central axis of the conducting wire structure 100 are substantially the same.

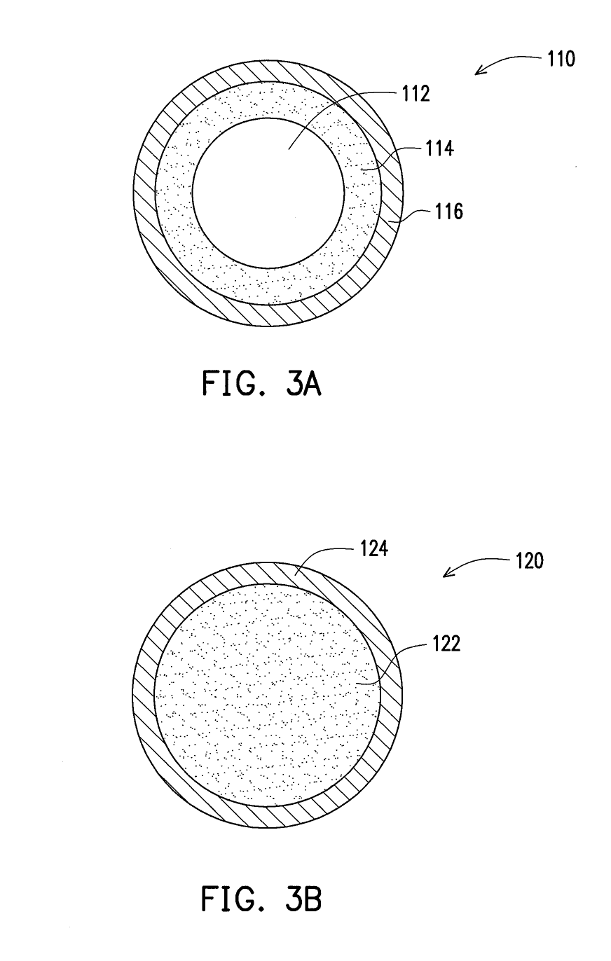

FIGS. 3A and 3B are respectively a cross-sectional diagram of a first core wire and a second core wire in the conducting wire structure of FIG. 2. Referring to FIGS. 2, 3A and 3B, in the embodiment, the second core wire 120 includes a copper wire 122 and a protection layer 124 cladding the copper wire 122, in which each of the first core wires 110 is composed of two metal materials. Each of the first core wires 110 includes a first metal layer 112 located at the center, a second metal layer 114 cladding the first metal layer 112 and a protection layer 116 cladding the second metal layer 114, in which the material of the first metal layer 112 is aluminium or aluminium-magnesium alloy for forming the major structure of the first core wire 110 and the material of the second metal layer 114 is copper. The heat-withstanding temperature of the first core wires 110 and the second core wires 120 is greater than 90° C. and the temperature of the conducting wire structure 100 during transmitting electric power is not over 90° C.

Based on the description above, the first metal layer 112 is clad with the second metal layer 114 of the first core wire 110, such that the diameter of the first core wire 110 is between 0.17 mm and 0.19 mm. Furthermore, the second core wires 120 are disposed surrounding the first core wires 110. In this way, the current is transmitted along the surfaces of the second metal layers 114 of the first core wires 110 and the surfaces of the second core wires 120 due to the surface effect of current while the conducting wire structure 100 is transmitting electric power. That means the core wires 110 and 120 in the conducting wire structure 100 of the invention have larger surface areas for loading larger currents. As a result, under a better current transmission efficiency, the conducting wire structure 100 of the present invention has an increased mechanical property and a reduced cost because the first core wires 110 substitute the portion of the conventional copper wire with the first metal layer 112 in non-copper material without affecting the current transmission efficiency and the first metal layer 112 has a better mechanical property and a lower fabrication cost in comparison with the second metal layer 114.

In addition, both the protection layers 116 and 124 are made of tin, which can prevent the conducting wire structure 100 from oxidization and be helpful for welding process technology between the conducting wire structure 100 and the electronic component 300 so as to increase the connection strength between the conducting wire structure 100 and the electronic component 300 electrically connected to the conducting wire structure 100. For example, during welding the conducting wire structure 100 onto the electronic component 300 (for example, a circuit board), due to the material characteristic of a lower fusion point with tin material, the fusing effect is realized between each of the core wires 110 and 120 and the electronic component 300, which increases the contacting area to make a better electrical connection effect between the conducting wire structure 100 and the electronic component 300.

In more details, due to the material characteristic of the first metal layer 112, the first core wire 110 is lighter and has a higher tensile strength. The second metal layer 114 is made of copper and entirely clads the first metal layer 112 by means of cladding welding fabrication technology, so that a firm metallurgical joining is formed between the metal layers 112 and 114, and after the fabrication, the first core wires 110 can be performed by successive processes of stretching and anneal processing just like processing wires in a single metal. Moreover, during the stretching process, the wire diameters of the first metal layer 112 and the second metal layer 114 are varied in a same proportion; i.e., the volume proportion of the first metal layer 112 over the second metal layer 114 keeps constant and unchanged.

In order to make the first core wires 110 have an integral material characteristic both of the first metal layer 112 and the second metal layer 114, the proportion of the volume of the second metal layer 114 over the volume sum of the first metal layer 112 and the second metal layer 114 is roughly less than 40%, and preferably between 32% and 38% or between 38% and 40%. In addition, the present invention does not limit the way of complexing the above-mentioned first metal layer 112 and second metal layer 114. For example, when the proportion of the volume of the second metal layer 114 over the volume sum of the first metal layer 112 and the second metal layer 114 is over 38%, the first metal layer 112 and second metal layer 114 are combined by the above-mentioned cladding welding. When the proportion of the volume of the second metal layer 114 over the volume sum of the first metal layer 112 and the second metal layer 114 is under 38%, a electroplating process is performed to make the first metal layer 112 plated by the second metal layer 114 thereon. A designer can select an appropriate processing to combine the first metal layer 112 with the second metal layer 114 according to the fabrication technology and the relevant specification.

In summary, in the above-mentioned embodiment of the present invention, the core wires in a conducting wire structure includes first core wires and second core wires twisted with each other, in which the first core wires are located at the center of the conducting wire structure and the second core wires are arranged surrounding the first core wires and the first core wire is composed of multiple metal materials. In this way, the current is transmitted through the second core wires 120 and the second metal layers around the structures of the first core wires to make the conducting wire structure have a better current transmission efficiency. In addition, by changing the first metal layer at the structure center of the first core wire with a metal material in better mechanical property and lower cost, the first core wire has better structure characteristic. As a result, the conducting wire structure of the present invention has a lower fabrication cost to meet the efficiency and structure characteristic required by transmitting electric power.

It will be apparent to those skilled in the art that various modifications and variations can be made to the structure of the invention without departing from the scope or spirit of the invention. In view of the foregoing, it is intended that the invention covers modifications and variations of this invention provided they fall within the scope of the following claims and their equivalents.

What is claimed is:

1. A conducting wire structure, used for transmitting electric power and comprising:
a plurality of first core wires and a plurality of second core wires twisted together with each other, wherein each of the first core wires is composed of multiple metal materials, a first metal layer is located at the center of the first core wire and the first metal layer is clad in a second metal layer.

2. The conducting wire structure as claimed in claim 1, wherein the quantity of the first core wires occupies less than 50% of the sum of the quantities of the first core wires and the second core wires.

3. The conducting wire structure as claimed in claim 2, wherein the quantity sum of the first core wires and the second core wires is 21, 34 or between 7 and 34.

4. The conducting wire structure as claimed in claim 3, wherein heat-withstanding temperatures of the first core wires and the second core wires are greater than 90° C. and the temperature of the conducting wire structure during transmitting electric power is not over 90° C.

5. The conducting wire structure as claimed in claim 1, wherein the conducting wire structure is used for transmitting electric power with voltage absolute values ranging from 3.3V to 60V, wherein the voltage absolute value is 3.3V, 5V, 12V, 16V, 19V, 20V and 60V.

6. The conducting wire structure as claimed in claim 1, wherein the first core wires are arranged at the center of the conducting wire structure and the second core wires are arranged roughly outside the first core wires.

7. The conducting wire structure as claimed in claim 6, wherein the quantity sum of the first core wires and the second core wires is 21, 34 or between 7 and 34.

8. The conducting wire structure as claimed in claim 7, wherein heat-withstanding temperatures of the first core wires and the second core wires are greater than 90° C. and the temperature of the conducting wire structure during transmitting electric power is not over 90° C.

9. The conducting wire structure as claimed in claim 6, wherein the distances between those among the second core wires most close to the first core wires from the central axis of the conducting wire structure are substantially the same.

10. The conducting wire structure as claimed in claim 9, wherein the quantity sum of the first core wires and the second core wires is 21, 34 or between 7 and 34.

11. The conducting wire structure as claimed in claim 10, wherein heat-withstanding temperatures of the first core wires and the second core wires are greater than 90° C. and the temperature of the conducting wire structure during transmitting electric power is not over 90° C.

12. The conducting wire structure as claimed in claim 1, wherein the proportion of the volume of the second metal layer over the volume sum of the first metal layer and the second metal layer is substantially less than 40%, between 32% and 38% or between 38% and 40%.

13. The conducting wire structure as claimed in claim 1, wherein the material of the first metal layer is aluminium or aluminium-magnesium alloy and the material of the second metal layer is copper.

14. The conducting wire structure as claimed in claim 1, wherein each of the first core wires further comprises:
a protection layer, cladding the second metal layer for preventing the conducting wire structure from oxidization and increasing the connection strength of the conducting wire structure electrically connected to other electronic components.

15. The conducting wire structure as claimed in claim 14, wherein the material of the protection layer is tin.

16. The conducting wire structure as claimed in claim 1, wherein each of the second core wires comprises:
a copper wire and a tin protection layer outside the copper wire, wherein the conducting wire structure is used for a switching power supply.

17. The conducting wire structure as claimed in claim 1, wherein the diameter of the first core wire is between 0.17 mm and 0.19 mm.

18. The conducting wire structure as claimed in claim 1, wherein the quantity sum of the first core wires and the second core wires is 21, 34 or between 7 and 34.

19. The conducting wire structure as claimed in claim 18, wherein heat-withstanding temperatures of the first core wires and the second core wires are greater than 90° C. and the temperature of the conducting wire structure during transmitting electric power is not over 90° C.
